(19) United States
(12) Patent Application Publication
(10) Pub. No.: US 2002/0194599 A1
(43) Pub. Date: Dec. 19, 2002

(54) Television program display information

(75) Inventor: Dale Mountain, Bradford (GB)

Correspondence Address: Mark G. Kachigian, Head, Johnson & Kachigian, 228 West 17th Place, Tulsa, OK, 74119, US

(73) Assignee: PACE MICRO TECHNOLOGY PLC.

(21) Appl. No.: 10/172,430

(22) Filed: Jun. 14, 2002

(30) Foreign Application Priority Data
Jun. 15, 2001 (GB) 0114583.8

(51) Int. Cl. H04N 5/445

(52) U.S. Cl. 725/39; 725/40

(57) ABSTRACT

The invention which is the subject of this application relates to a television system which includes a display screen connected to a means for receiving and processing broadcast digital data. Some of the data can be used to generate an electronic programme guide (EPG) on the screen. The invention provides for the generation of a display on the screen indicting programme information relating to a programme available for viewing from a viewer selected subset of television channels. The display can relate to one programme on one channel, such as indicating the start time of the same, or the display can be provided in an animated manner to indicate programme information for a range of channels.

The invention which is the subject of this application relates to a system and method for the display of information to a viewer of a television system. Said system typically comprises a television set with a display screen, and said set is connected to or includes a broadcast data receiver (BDR) to receive digital data broadcast from a remote location. The data typically comprises video and audio data, from which television programmes can be generated, and auxiliary data from which other services can be generated. One such further service is an Electronic Programme Guide (EPG) which is an on screen display which can show a variety of information, including a series of grids to show details such as time, channel and the title of programmes available for viewing from a range of available channels and more specific information relating to user selected programmes.

The EPG replaces traditional newspaper or magazine listings of programmes and is required because of the quickly increasing number of channels which are available for viewing. However, while the EPG is a useful tool for the viewer of a television system, the user is required to first select the EPG option and then go through a number of screen displays and make a number of selections to make a viewing choice. While they are doing this the viewer is not watching any programme and therefore may be missing an important or entertaining part of a programme and/or may be irritated by the number of selections, typically via remote control key presses, which they are required to make.

The aim of the present invention is to provide an improved EPG service and furthermore an improvement which, once activated, can provide information to the viewer without the viewer having to subsequently select to access the same.

In a first aspect of the invention there is provided a television system comprising a display screen connected to a receiving means for receiving digital data broadcast from a remote location, said receiving means including the facility to generate an electronic programme guide (EPG) on the display screen, said EPG generated from received data and relating to television programmes and television channels available for selection for viewing at that instant of use of the system and/or in the future and characterised in that selection means are provided to allow the viewer to identify and select a subset of channels from television channels available for display and, at the time for transmission of programmes on a channel in the subset of channels, a display is generated on screen to indicate to the viewer information relating to the programme.

In one embodiment the EPG generates the display to include the time, programme title and channel on which the programme is to be transmitted.

Typically the subset of selected channels is generated by the data receiving means in response to viewer selection instructions received by the data receiving apparatus.

Preferably the display is generated as a window display on the display screen to allow any video display being viewed at that time to continue to be partially viewable. The display typically remains on the screen for a predetermined period of time whereupon at the expiry of the time period the display is removed.

In one embodiment the display for a programme to be shown on a subset channel is generated when the data receiving means receives data for said programme which indicates that the programme is about to start. Alternatively the display for a programme to be shown on a subset channel is generated when the data receiving means receives data indicating that the preceding programme has ended.

Typically the display is generated a period of time prior to the transmission time of the programme.

In a further aspect of the invention there is provided a television system, said system including the facility to generate an electronic programme guide (EPG) display on a display screen, said EPG generated from received data processed by a broadcast data receiver (BDR) connected to the display screen and relating to television programmes available for selection for viewing at that instant and/or in the future and characterised in that a display is generated on the display screen in response to a viewer selection, to indicate details relating to programmes available for viewing on a range of available channels, said display, when generated, is animated in that the display changes over time with lines of text relating to programmes on particular channels introduced and removed after successive time periods.

In one embodiment the lines of text are introduced and removed in a scrolling manner. Typically the scrolling occurs at fixed time intervals.

Preferably, at any one time interval, the information displayed in the display relates to programmes on one channel.

Preferably, the information relates to programmes shown on a subset of channels selected by the viewer from those channels which are available for viewing. The information is displayed for the subset of channels in a continuous loop until the display is selected to be removed by the viewer. Typically the display which is generated includes information relating to programmes currently and next to be shown on one channel and is displayed in a carousel fashion.

Thus, the display is not generated for every available channel but rather when a programme from a list of selected channels is due to be displayed. Preferably the facility of the invention as herein described can be enabled or disabled by the input of a control signal by the viewer, typically via a remote control.

By providing animation of the display so the size of the display with respect to the screen can be minimised and the amount of information displayed to the viewer maximised over a given time period without the need for the viewer to continually enter control signals to change the display via a remote control device or miss what they are already watching. Furthermore the information is focussed to the channels of interest to the viewer.

Thus the viewer can instantly see what programs are showing now and next on other channels. This is in contrast to current systems where, if a viewer wants to see what is on other channels, they must continually use the remote control to scan through the channels on the EPG.

Typically the animation of the display is such that the programme and channel information is displayed in a “carousel” fashion.

Specific embodiments of the invention are now described with reference to the accompanying drawings; wherein

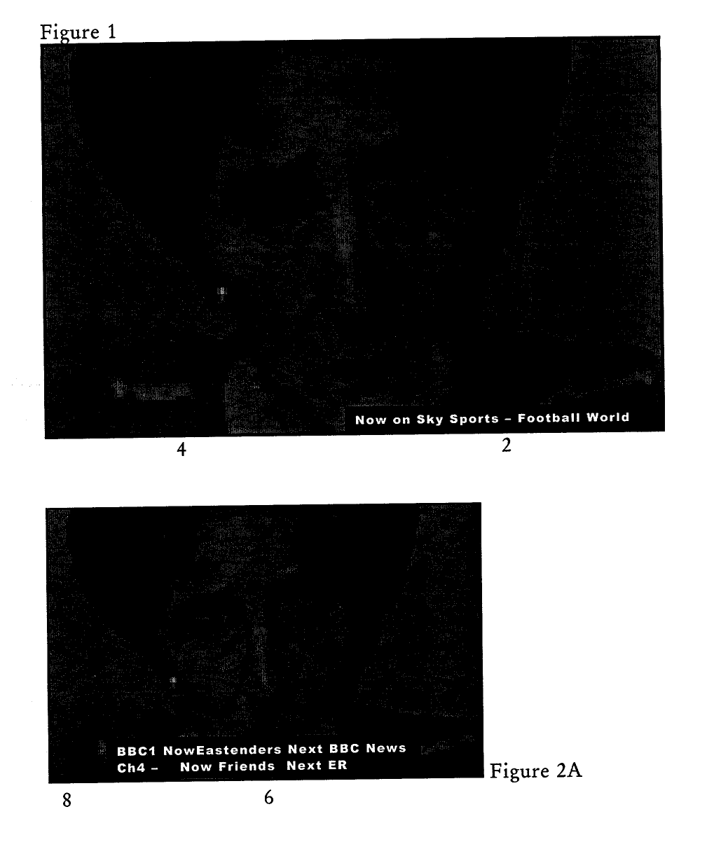

FIG. 1 illustrates a display in accordance with the invention in a first embodiment;

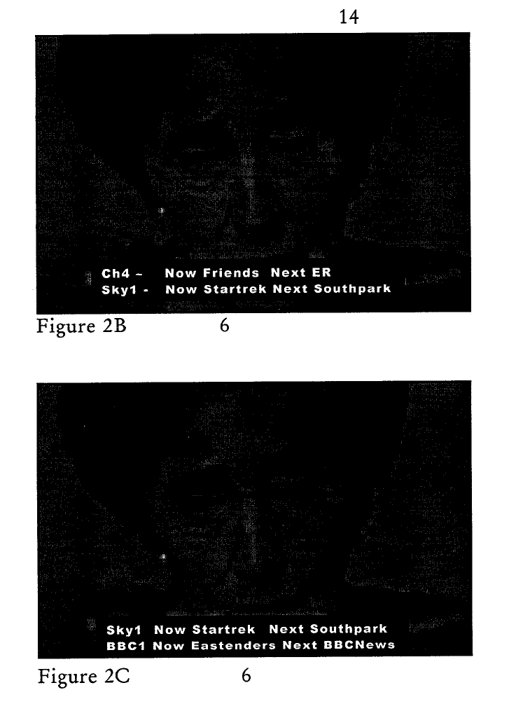

FIGS. 2A-C illustrate a display in accordance with the invention in a second embodiment.

Conventionally, many viewers only watch programmes which are broadcast on a subset of the television channels which are selected from the complete range of channels which are available. The subset of channels can typically relate to the viewers own personal interests and preferences. However, in practice the viewer can often miss a programme they would have wished to watch because they were unaware of the fact that it is being transmitted.

This invention, in one embodiment, makes reference to a subset of a specific list of channels which are stored in the memory of the television system, typically as part of a Broadcast Data Receiver (BDR), which is the apparatus provided to receive and process the video, audio and auxiliary data from which the television programmes and auxiliary services such as the EPG can be generated.

Thus in accordance with the invention the viewer generates a list of preferred channels which becomes the subset of television channels, details of which are held in the memory in the BDR. The BDR receives data indicating the start and end times of programmes and when EPG data indicating this is received, any data received for any of the channels in the stored subset which indicates a programme change, i.e. indicating the end of one programme and the start of the next, the BDR processes the same and uses it to trigger and generate a display, preferably of a relatively small size. The message display 2 is generated on the display screen 4 of the television system as shown in FIG. 1 and includes information which indicates to the viewer that a new programme is available for viewing on one of the channels in the previously selected subset of channels. The information provided includes the programme title, transmission time and channel location.

As the display is generated for a programme to be shown on one of the channels selected by the viewer there is a reasonable case that the programme is of potential interest to them and the viewer will not regard the display as being unnecessary or irritating and as being of benefit to them

The system of the present invention has the benefit of being channel based in that once the channels have been selected, then the programmes subsequently available on those channels are indicated to the viewer rather than just one particular programme. It also means that the viewer is not required to have knowledge of a particular programme prior to the display and therefore the system of this invention is a provider of information rather than simply a conventional programme reminder service.

The present invention therefore provides a means for the viewer to be aware of programs happening on their favourite channels and hence they will be aware of programs which they otherwise wouldn't be aware of.

FIGS. 2A-C illustrate a further embodiment of the invention wherein the display which is used is particularly informative and allows the display of a relatively large range of information in a small display window 6 on the screen 8. The embodiment shows the display of the current programme being shown and the next program to be shown for a subset of channels, BBC1, Channel 4 and Sky 1. The information relating to the programmes could alternatively be with respect to all available channels but more preferably relates to those channels in the preselected subset of the channels.

The display 6 is generated in a scrolling carousel fashion by providing a scrolling loop of either 1 or 2 lines of text. In FIG. 2A, programme information for the first channel BBC1 and Channel 4 is shown. The display 6 then changes, 10 seconds later, to that shown in FIG. 2B by means of a scrolling loop which causes the programme information for the channel BBC1 to disappear, and programme information for Channel 4 to scroll up and be shown on the display along with information for the Channel Sky 1. A further 10 seconds pass and the information for the channel, Sky 1, scrolls up to replace that for Channel 4 in the display 6 and the information of BBC1 is again introduced as shown in FIG. 2C. It should be appreciated that the display 6 can be provided to carry information for more than one channel and the scrolling can be set at any desired number of lines to scroll in one movement and at selected time intervals. The scrolling movement can then continue for as long as the viewer wishes the display to be shown and when the end of the channels in the subset of channels is reached, the channel at the start of the subset is again displayed so as to form a loop of channel information.

In one embodiment the display window can be generated using transparent colours so it does not impact the viewing of the video image 8 being displayed on the screen.

The provision of the scrolling animation of the display allows the viewer to be aware of programmes available for viewing without the need for repeatedly pressing remote control buttons to generate the repeated control signals. However, the feature of the display can itself be enabled or disabled by the use of the remote control. This invention therefore allows the viewer to keep track of what is or is about to be transmitted on their favourite channels without the need for remote control interaction or disturbing current viewing.

1. A television system comprising a display screen connected to a receiving means for receiving digital data broadcast from a remote location, said receiving means including the facility to generate an electronic programme guide (EPG) on the display screen, said EPG generated from received data and relating to television programmes and television channels available for selection for viewing at that instant of use of the system and/or in the future and characterised in that selection means are provided to allow the viewer to identify and select a subset of channels from television channels available for display and at the time for transmission of programmes on a channel in the subset of channels a display is generated on screen to indicate to the viewer information relating to the programme.

2. A system according to claim 1 characterised in that the EPG generates the display to include the time, programme title and channel on which the programme is to be transmitted.

3. A system according to claim 1 characterised in that the subset of selected channels is generated by the data receiving means in response to viewer selection instructions received by the data receiving apparatus.

4. A system according to claim 1 characterised in that the display is generated as a window display on the display screen to allow any video display being viewed at that time to continue to be partially viewable.

5. A system according to claim 1 characterised in that the display remains on the screen for a predetermined period of time whereupon at the expiry of the time period the display is removed.

6. A system according to claim 1 characterised in that the display for a programme to be shown on a subset channel is generated when the data receiving means receives data for said programme which indicates that the programme is about to start.

7. A system according to claim 1 characterised in that the facility is enabled or disabled by the input of a control signal by the viewer of the system.

8. A system according to claim 1 characterised in that the display for a programme to be shown on a subset channel is generated when the data receiving means receives data indicating that the preceding programme has ended.

9. A system according to claim 1 characterised in that the display is generated a period of time prior to the transmission time of the programme.

10. A television system, said system including the facility to generate an electronic programme guide (EPG) display on a display screen, said EPG generated from received data processed by a broadcast data receiver (BDR) connected to the display screen and relating to television programmes available for selection for viewing at that instant and/or in the future and characterised in that a display is generated on the display screen in response to a viewer selection, to indicate details relating to programmes available for viewing on a range of available channels, said display, when generated, is animated in that the display changes over time with lines of text relating to programmes on particular channels introduced and removed after successive time periods.

11. A system according to claim 10 characterised in that the lines of text are introduced and removed in a scrolling manner.

12. A system according to claim 11 characterised in that the scrolling occurs at fixed time intervals.

13. A system according to claim 10 characterised in that at any one time interval, the information displayed in the display relates to programmes on one channel.

14. A system according to claim 10 characterised in that the information relates to programmes shown on a subset of channels selected by the viewer from those channels which are available for viewing.

15. A system according to claim 14 characterised in that the information is displayed for the subset of channels in a continuous loop until the display is selected to be removed by the viewer.

16. A system according to claim 10 characterised in that the display is generated in response to a viewer instruction to the BDR via a remote control unit signal.

17. A system according to claim 10 characterised in that the display which is generated includes information relating to programmes currently and next to be shown on one channel.

18. A system according to claim 10 characterised in that the programme information is displayed in a carousel fashion.
